(19) United States
(12) Patent Application Publication
(10) Pub. No.: US 2015/0112889 A1
(43) Pub. Date: Apr. 23, 2015

(54) ACHIEVING MARGIN CAPITAL EFFICIENCIES USING LINEAR PROGRAMMING

(71) Applicant: Chicago Mercantile Exchange, Inc., Chicago, IL (US)

(72) Inventors: John Kerpel, Chicago, IL (US); John Labuszewski, Westmont, IL (US); Richard Co, Chicago, IL (US); John Nyhoff, Darien, IL (US); Joseph Turner, Chicago, IL (US)

(73) Assignee: CHICAGO MERCANTILE EXCHANGE, INC., Chicago, IL (US)

(21) Appl. No.: 14/057,363

(22) Filed: Oct. 18, 2013

(51) Int. Cl. G06Q 40/06

(52) U.S. Cl. CPC G06Q 40/06
USPC 705/36 R

(57) ABSTRACT

A minimum margin requirement associated with an account may be determined by calculating, by a computer system, a first margin requirement for each of a plurality of derivatives positions associated with an account, calculating, by the computer system, a second spread margin requirement for each of one or more spread positions corresponding to the plurality of derivatives positions associated with the account, and determining, by the computer system, a minimum account margin requirement for the account using a linear programming technique and based on the first margin requirement for each of the plurality of derivatives positions and the second spread margin requirement for each of the one or more spread positions.

### BACKGROUND

In many financial markets, holders of positions in traded assets are required to maintain a minimum balance of cash or other security as a “margin” or performance bond. This performance bond may be used to reduce the risk to other market participants of losses associated with the position holder failing to fulfill its obligations. If a holder of a portfolio defaults, the performance bond for that portfolio can be used to reduce losses resulting from the holder no longer being able to cover its positions. Often, a portfolio may include two or more positions, where each position has an individual performance bond requirement. As such, there remains a need for improved systems and techniques to calculate performance bond values associated with various types of products to minimize the performance bond requirements for the complete portfolio.

### SUMMARY

This Summary is provided to introduce a selection of concepts in a simplified form that are further described below in the Detailed Description. This Summary is not intended to identify key or essential features of the invention.

In at least some embodiments, a performance bond (e.g., a margin requirement) may be applicable to holdings held in a portfolio (e.g., an account). A first margin requirement may be calculated for each of a plurality of derivatives positions associated with the account. A second spread margin requirement may be determined for each of one or more spread positions corresponding to the plurality of derivatives positions associated with the account. A minimum third account margin requirement may be determined for the account using a linear programming technique, where the third account margin requirement may be based on the first margin requirement for each of the plurality of derivatives positions and the second spread margin requirement for each of the one or more spread positions.

In at least some embodiments, an account including two or more derivatives positions may be identified, wherein each of the derivatives positions may have an associated first margin requirement. A second spread margin requirement may be determined for each of one or more spread positions corresponding to the plurality of derivatives positions associated with the account. A minimum third account margin requirement may be determined for the account using a linear programming technique, where the third account margin requirement may be based on the first margin requirement for each of the plurality of derivatives positions and the second spread margin requirement for each of the one or more spread positions.

In at least some embodiments, a computer system for determining a margin requirement for an account may include at least one processor and at least one non-transitory memory. In some cases, the non-transitory memory may store instructions that, when executed, cause the computer system to perform operations that cause the computer system to receive account information about an account holding two or more derivatives positions. Each of two or more derivatives positions may have an associated first margin requirement. The computer system may also calculate a second spread margin requirement for each of one or more spread positions corresponding to the plurality of derivatives positions included in the account and determine a minimum third account margin requirement for the account using a linear programming technique. The linear programming technique may calculate the third account margin requirement using the first margin requirement for each of the plurality of derivatives positions and the second spread margin requirement for each of the one or more spread positions.

Embodiments include, without limitation, methods for determining a margin requirement for an account, computer systems configured to perform such methods, and computer-readable media storing instructions that, when executed, cause a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing trading systems and methods according to at least some embodiments.

FIG. 2 shows a block diagram representation of a system for determining a margin requirement for an account using linear programming techniques according to at least some embodiments.

FIG. 3 shows an illustrative account of FIG. 2 having a holding of derivatives and illustrative spreads that correspond to the derivatives.

FIG. 4 is a flow chart showing steps performed in methods according to at least some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

### Exemplary Operating Environment

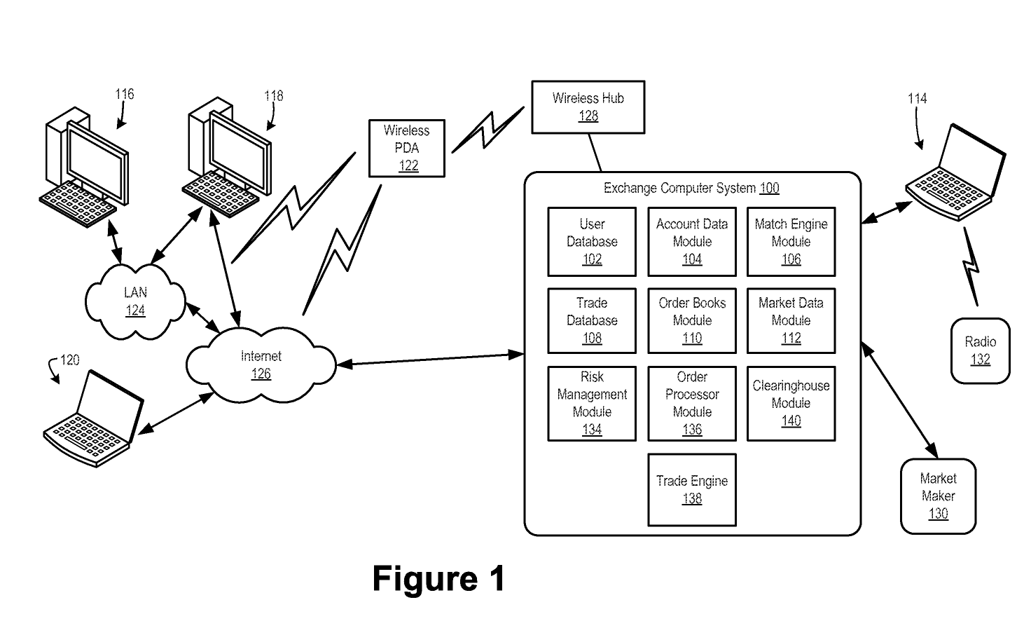

Aspects of at least some embodiments can be implemented with computer systems and computer networks that allow users to communicate trading information. An exemplary trading network environment for implementing trading systems and methods according to at least some embodiments is shown in FIG. 1. The implemented trading systems and methods can include systems and methods, such as are described herein, that facilitate trading and other activities associated with financial products based on currency pairs.

Computer system 100 can be operated by a financial product exchange and configured to perform operations of the exchange for, e.g., trading and otherwise processing various financial products. Financial products of the exchange may include, without limitation, futures contracts, options on futures contracts (“futures contract options”), and other types of derivative contracts. Financial products traded or otherwise processed by the exchange may also include over-the-counter (OTC) products such as OTC forwards, OTC options, etc.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses one or more 64-bit processors. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out clearinghouse operations. Module 140 may receive data from and/or transmit data to trade database 108 and/or other modules of computer system 100 regarding trades of futures contracts, futures contracts options, OTC options and contracts, and other financial products. Clearinghouse module 140 may facilitate the financial product exchange acting as one of the parties to every traded contract or other product. For example, computer system 100 may match an offer by party A to sell a financial product with a bid by party B to purchase a like financial product. Module 140 may then create a financial product between party A and the exchange and an offsetting second financial product between the exchange and party B. As another example, module 140 may maintain margin data with regard to clearing members and/or trading customers. As part of such margin-related operations, module 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc. As discussed in further detail below, module 140 may determine values for performance bonds associated with trading in products based on various types of currency pairs.

Each of modules 102 through 140 could be separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-140).

Computer device 114 is shown directly connected to exchange computer system 100. Exchange computer system 100 and computer device 114 may be connected via a Ti line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems (e.g., computer systems of clearing member firms), regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, clearinghouse module 140 and/or other modules of exchange computer system 100 may include computer-executable instructions for performing operations associated with determining performance bond contributions associated with holdings in products that are based on various types of currency pairs.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “system 100”) receives, stores, generates and/or otherwise and processes data so as to determine values of performance bonds that are associated with holdings in various types of financial products. A performance bond, also known as a “margin” or a “margin requirement” is typically calculated by an exchange, by a clearinghouse or by some other market entity to help reduce risk associated with a trader failing to fulfill obligations related to a particular asset or group of assets. A performance bond may represent a minimum amount of funds that must be deposited by a customer with a broker, by a broker with a clearinghouse member and/or by a clearinghouse member with a clearinghouse or exchange. These funds may then be used, for example, to help assure that losses associated with trading positions can be covered. In some cases, one or more mathematical algorithms (e.g., a direct mathematical algorithm and/or an iterative mathematical algorithm) may be used to determine a minimum margin requirement for two or more holdings in an account. For example, one or more mathematical optimization algorithms may be used to find a “best available” solution when finding the minimum margin requirement for the account. In some cases, a convex programming optimization model may be used, such as, but not limited to, linear programming, geometric programming, conic programming, integer programming, quadratic programming, or the like.

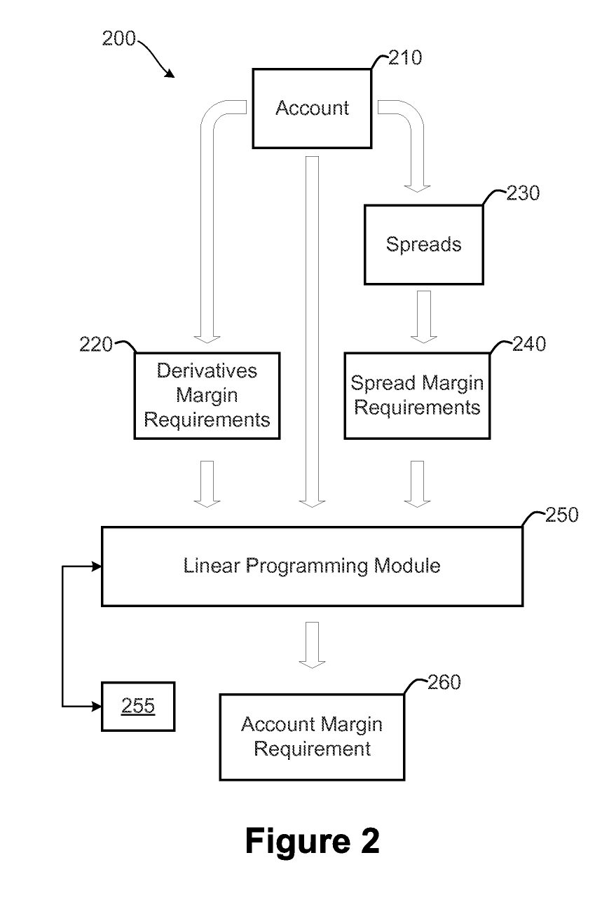

FIG. 2 shows a block diagram representation of a system for determining a margin requirement for an account using linear programming techniques according to at least some embodiments. For example, a computer system, such as the exchange computer system 100 of FIG. 1, may include account information 210 that may be stored in the account data module 104, and a linear programming module 250. In some cases, the linear programming module 250 may be an individual component of the computer system 200 and/or at least a portion of the linear programming module 250 may be incorporated in the risk management module 134.

The account information 210 may include information about two or more holdings, such as a futures derivatives product, an OTC derivatives product, and/or the like. Each individual holding in the account, such as the futures derivatives product and/or the OTC derivatives product, may entail some risk. As such, the clearinghouse may require a performance bond (e.g., the derivatives margin requirement 210) for each of the individual holdings indicated in the account information 210. In some cases, the margin requirements may include an amount of cash, or other collateral, that an investor is required to provide into a margin account to ensure performance of an underlying derivatives contract. The derivatives margin requirement 210 may include an initial margin requirement that must be provided, such as into the margin account, to allow a trader to begin trading the derivatives products, a maintenance margin requirement (e.g., a minimum balance maintained in the margin account), and/or a variation margin requirement (e.g., an amount of cash and/or collateral) to return the margin account to the initial margin requirement amount when the account drops below the maintenance margin requirement amount.

In some cases, spreads (e.g., the spreads 230) may have two or more “legs” or components (e.g., a derivatives product held in the account 210) that have some relation to each other. Spreads 230 may be used to speculate on the possibly divergent movements between the two different but nonetheless related products. For example, a spread may be taken between a Standard & Poor's (S&P) 500 based futures product and a NASDAQ-100 based futures product, such as a long position in S&P 500 futures and a short position in NASDAQ-100 futures, and the like. Other illustrative spreads may include a spread between an S&P 500 based futures product and at least one of a Dow Jones Industrial Average (DJIA) based futures product, an S&P Midcap 400 based product, or the like. Like the individual component derivatives product, each of the illustrative spreads 230 include some risk and, therefore, a clearinghouse (e.g., the clearinghouse module 140) will likely require and/or compute a performance bond (e.g., a margin requirement) to secure the financial integrity of the transaction.

In many cases, a spread may involve measurably less risk (e.g., monetary risk) than would be encountered in an outright position in either of the individual component futures products comprising the legs of the spread. As such, the clearinghouse module 140 may offer margin breaks, such as a reduced spread margin requirement (e.g., the spread margin requirements 240), when a spread is recognized. Often, the account 210, or multiple related accounts (e.g., two or more accounts associated with a trader), may hold multiple futures and/or other derivatives positions that may be used to recognize one or more spread positions. As such, a total margin requirement 260 for the account, or multiple related accounts, may be different based on how the different spreads 230 and/or spread margins 240 are recognized. In some cases, linear programming techniques may be used, such as by the linear programming module 250, to identify one or more spreads 230 that may be identified within the account 210, and/or multiple related accounts. In some cases, the linear program module 250 may be used to minimize, or otherwise reduce, the account margin requirement 260 as applied to the account and/or multiple related accounts.

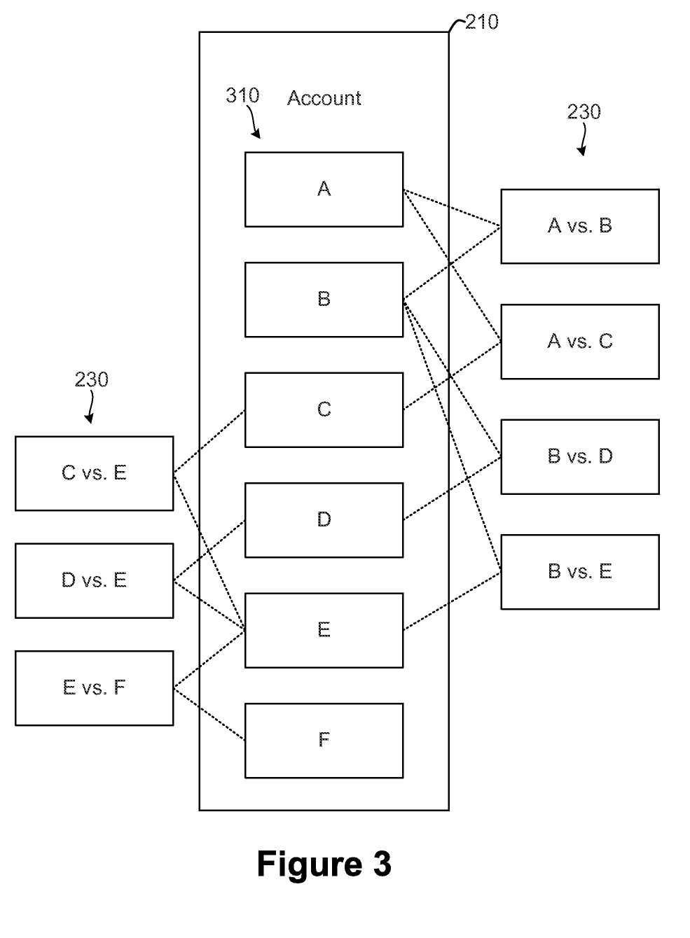

FIG. 3 shows an illustrative account 210 of FIG. 2 holding two or more positions 310 (e.g., outright derivatives contracts A-F as illustrated in Table 1) and illustrative spreads 230 (e.g., the spreads illustrated in Table 2) that correspond to the positions 310. For example, the positions 310 may include one or more derivatives products (e.g., a futures derivatives product, an OTC derivatives product, etc.), as shown below in Table 1. The account 210 may include different outright positions in different futures contracts (e.g., the derivatives contracts A-F). In some cases, each of the holdings 310 may have an associated margin requirement that may be determined by the clearinghouse module 140. An account margin requirement may be determined by summing the derivatives margin requirements 220 for the individual holdings 310 in the account 210. In the example shown in Table 1, the account margin requirement may be determined as the summed total of the different margin requirements of the individual holdings 310.

TABLE 1
Outright positions

| | | | Outright | |
|---|---|---|---|---|
| Futures | Long | Short | Margin per | Margin |
| Contract | Position | Position | Contract | Requirement |
| A Outright | 100 | — | $5,000 | $500,000 |
| B Outright | — | 50 | $4,000 | $200,000 |
| C Outright | 230 | — | $2,500 | $575,000 |
| D Outright | 40 | — | $6,000 | $240,000 |
| E Outright | — | 20 | $6,000 | $120,000 |
| F Outright | — | 400 | $3,750 | $1,500,000 |

| | |
|---|---|
| Un-optimized System Margin requirement: | $3,135,000 |

In some cases, the spread margins 230, and an accompanying “margin break”, may be determined, such as by the computing device 210. For example, the linear programming module 250 may be used to identify a combination of long and/or short positions “spread” between designated markets. The resulting spreads may allow the account to have a reduced risk position. In some cases, the spreads 230 may include a ratio corresponding to an allocation of holdings 310 (e.g., outright derivatives contracts) used to form each leg of the spread. As can be seen in Table 2, the spread ratio may differ between spreads due to one or more different characteristics of the underlying derivatives products. For example, a spread between contracts A vs. B may have a ratio of 1:1 and the spread between contracts A vs. C may have a ratio of 1:2.

TABLE 2
Possible spread positions and associated spread margins

| Spread | | Margin | | |
|---|---|---|---|---|
| Margins | Recognized | Break vs. | Outright | Spread |
| Position | Spread Ratio | Outrights | Margin | Margin |
| A vs. B Spread | 1:1 | 90% | $9,000 | $900 |
| A vs. C Spread | 1:2 | 80% | $10,000 | $2,000 |
| B vs. D Spread | 1:1 | 75% | $10,000 | $2,500 |
| B vs. E Spread | 4:3 | 75% | $34,000 | $8,500 |
| C vs. E Spread | 5:1 | 60% | $18,500 | $7,400 |
| D vs. E Spread | 1:1 | 50% | $12,000 | $6,000 |
| E vs. F Spread | 2:5 | 40% | $30,750 | $18,450 |

As discussed, the outright holdings 310 in the account 210 may correspond to unique futures contracts, such as a long position in S&P 500 futures and a short position in NASDAQ-100 futures, and the like. In some cases, at least one spread may be determined between these related, but distinct, holdings, (e.g., the long position in S&P futures and the short position in NASDAQ-100 futures) and may be referred to as an “inter-market spread.” In some cases, an “intra-market spread” or “calendar spread” may be determined between positions in different contract or delivery months in the same futures contract, for example, a long position in March S&P 500 futures and a short position in June S&P 500 futures. While an inter-market spread may be subject to a lesser margin requirement than either of the individual holdings used to form the legs of the spread, an intra-market spread may have an even more modest margin requirement than an inter-market spread. For example, a correlation between futures contracts in different delivery months may be greater than the correlation between two contracts in distinct markets. Similarly, outright positions may require greater performance bonds than spread positions.

The linear programming module 250 may be configured to determine one or more combinations of the holdings 310 (e.g., derivatives positions) held in the account 210. For example, the linear programming module may use the holdings 310 as outright holdings 310 and/or as recognized spreads 230. The linear programming module 250 may also be configured to use one or more linear programming techniques (e.g., a simplex algorithm, a criss-cross algorithm, a conic sampling algorithm, an ellipsoid algorithm, a projective algorithm, and/or a path-following algorithm) to determine an account margin requirement 260. The account margin requirement 260 may use the determined combinations of the holdings 310 of the account 210 that is less than the sum of the margin requirements for each of the outright holdings 310 held in the account 210. For example, the linear programming module 250 may be used to determine a minimum, or minimal, margin requirement for the account 210 using the one or more linear programming techniques

Typically, linear programming techniques are applied when determining a way to achieve an optimal outcome of a problem, such as by finding a maximum solution and/or a minimum solution, given a particular set of constraints. These linear programming techniques may be utilized in a number of industries (e.g., financial, manufacturing, transportation, engineering, etc.) where businesses desire to optimize the allocation of limited resources while obtaining an desired result (e.g., maximizing profit, minimizing costs, etc.). When using linear programming techniques, the problem to be solved may be expressed as a linear function (e.g., a linear objective function) that is subject to one or more linear constraints (e.g., a linear equality constraint and/or a linear inequality constraint). The defined objective function subject to the linear constraints may be solved by any of a variety of linear programming techniques. For example, in one embodiment, the simplex algorithm may be used. The simplex algorithm is an iterative procedure for solving linear programming problems, which includes finding the optimum of a linear function subject to a number of linear constraints and may be able to provide fast solutions to large-scale applications. Other such linear programming techniques may be used such as a criss-cross algorithm, a conic-sampling algorithm, an ellipsoid algorithm, a projective algorithm, and/or a path-following algorithm. In some cases, linear programming problems may be solved using graphical methods, computational methods or a combination of graphical and computational methods.

In some embodiments, the objective function may correspond to minimizing the total margin requirements of the account 210, subject to particular constraints that may be seen in Tables 1 and 2. Illustrative constraints may include the number of holdings 310 (e.g., the holdings A-F), a number of positions in each individual holding 310 (e.g., 10 long contracts, 100 short contracts), the margin requirement 220 for each holding 310, a number of possible spreads 230 (e.g., the A vs. B spread, the D vs. E spread, etc.), the margin requirement 240 for each spread, a spread ratio for each of the spreads 230, and/or the like. The linear programming module 250 may apply one or more of the linear programming techniques mentioned above (e.g., the simplex algorithm, the criss-cross algorithm, a conic-sampling algorithm, an ellipsoid algorithm, a projective algorithm, and/or a path-following algorithm) to find a minimal and/or minimum account margin requirement 260 for the account 210. In some cases, the linear programming module 250 may use one or more of the identified constraints, either automatically or based on user input. For example, a user may specify, that the linear programming module 250 use particular ones of the identified constraints. In some cases, the linear programming module 250 may automatically identify particular constraints to use when determining the minimum account margin requirement 260. In some cases, the constraints may include restricting matching long and/or short positions of the holdings 310 so that the size of the spread position does not exceed the available outright positions used as the legs of the spreads 230.

In some cases, the linear programming module 250 may apply one or more of the linear programming techniques to find a solution for minimizing the overall margin requirements 260 the account 210. For example, the account 210 may include a plurality of holdings 310, as illustrated in Table 1 and FIG. 3, each subject to a margin requirement 220 determined by a clearinghouse, such as by the risk management module 134. Each of the holdings may include a specified number of positions (e.g., 50 long positions, 20 short positions, etc.). In some cases, as shown in Table 2 and FIG. 3, the exchange computer system 100, or a component of the exchange computer system 100 (e.g., the linear programming module) may determine one or more spreads 230 between the holdings 310, where each of the spreads 230 may be subject to a particular spread margin requirement 240 as determined by the clearinghouse. The spreads 240 may include a spread ratio that illustrates a particular relation between the different holdings 310 forming the legs of the spread. By applying one or more linear programming techniques to the problem of minimizing the overall margin requirement for the account 210 using the constraints illustrated in Tables 1 and 2, the linear programming module may determine one or more minimum and/or minimal solutions, as illustrated in Table 3.

TABLE 3
Optimized System Margin Requirement.

| | | Outright | | |
|---|---|---|---|---|
| | Recognized | Contracts or | Spread | Margin |
| Position | Spread Ratio | Spreads | Margin | Requirement |
| A Outright | Na | 28 | $5,000 | $140,000 |
| B Outright | Na | 0 | $4,000 | $0 |
| C Outright | Na | 0 | $2,500 | $0 |
| D Outright | Na | 4 | $6,000 | $24,000 |
| E Outright | Na | 0 | $6,000 | $0 |
| F Outright | Na | −203 | $3,750 | $761,250 |
| A vs. B Spread | 1:1 | 72 | $900 | $64,800 |
| A vs. C Spread | 1:2 | 0 | $2,000 | $0 |
| B vs. D Spread | 1:1 | 0 | $2,500 | $0 |
| B vs. E Spread | 4:3 | 5 | $8,500 | $42,500 |
| C vs. E Spread | 5:1 | 46 | $7,400 | $340,400 |
| D vs. E Spread | 1:1 | 36 | $6,000 | $216,000 |
| E vs. F Spread | 2:5 | 39 | $18,450 | $719,550 |

| | |
|---|---|
| Optimized System Margin Requirement | $2,308,500 |

(negative numbers = short positions)

In some cases, the exchange computer system may include a user interface 255 that may allow a user to view and/or modify one or more aspects of the method for minimizing margin requirements for the holdings within the account 210. In the illustrative embodiment of FIG. 2, the user interface 255 may be any suitable user interface that may allow the exchange computer system 100 (e.g., the linear programming module 250) to display and/or solicit information, as well as accept one or more user interactions with the exchange computer system 100 and/or the linear programming module 250. In some cases, the user interface 255 may be implemented at a location remote from the linear programming module 250 and may communicate to the data health management device 300 via the communication interface 340 and/or the communication link 350 (e.g., a wired Ethernet network, a wireless Ethernet network, the Internet, and the like). In some cases, a common user interface 255 may be used to communicate with one or more components of the exchange computer system 100, such as the account data module 104, the match engine module 106, the order books module 110, the risk management module 134, and/or the like. The user interface 255 (when provided) may permit a user to enter data such as account information (e.g., identification information for an account 210), identification of holding 310 to be associated with spreads 230, and the like. The user interface 255 may include one or more user interface screens 332 to facilitate interaction with a user. For example, one or more user interface screens 332 may be used to solicit information about the account 210, or accounts, for which the total margin requirement 260 is to be minimized and/or for displaying the information about the account margin requirement 260 as determined by the linear programming module 250. For example, a first screen may be configured to show account information as shown in Table 1, a second screen may be configured to show account information as shown in Table 2, and a third screen may be configured to show information about the account margin requirement 260 as shown in Table 3. The user interface 330 may further include a memory device that may be used for storing instructions and/or data for managing the display and/or use of the user interface screens. In some cases, user interface 330 may include a display and a distinct keypad. A display may be any suitable display. In some instances, the display may include or may be a liquid crystal display (LCD), and in some cases a fixed segment display or a dot matrix LCD display. If desired, user interface 330 may be a touch screen LCD panel that functions as both display and keypad. In some instances, a touch screen LCD panel may be adapted to solicit values for a number of operating parameters and/or to receive such values, but this is not required.

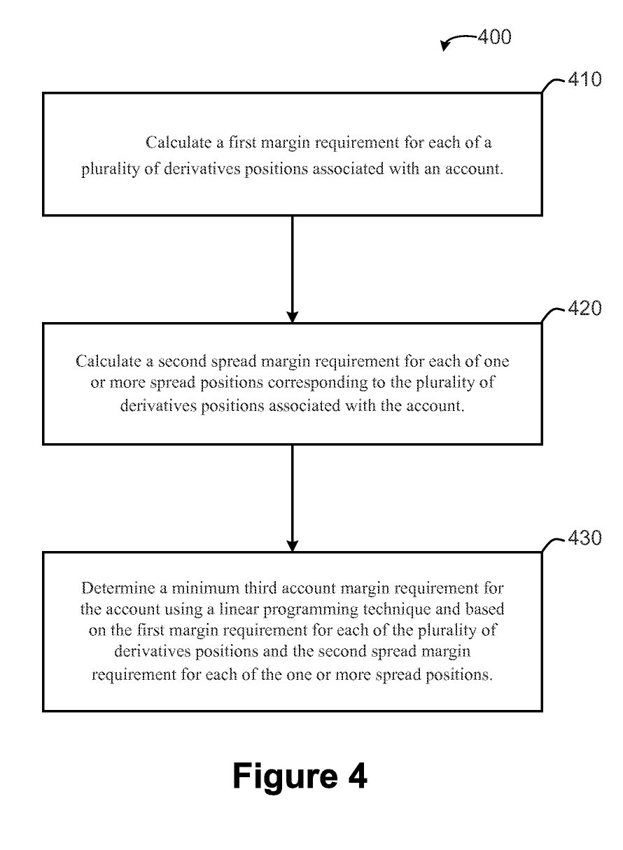

FIG. 4 is a flow chart showing steps performed in methods according to at least some embodiments. In some cases, an illustrative method 400 may begin at 410 by calculating, such as by at least a portion of the exchange computer system 100 (e.g., the linear programming module 250), a first margin requirement for each of a plurality of derivatives positions 310 associated with the account 210. At 420, the linear programming module 250 may calculate a second spread margin requirement for each of one or more spread positions 230 corresponding to the plurality of derivatives positions 310 associated with the account 210. At 430, the linear programming module 250 may determine a minimum third account margin requirement for the account using a linear programming technique and based on the first margin requirement for each of the plurality of derivatives positions 310 and the second spread margin requirement for each of the one or more spread positions 230. In some cases, the linear programming module may determine the one or more spread positions between two derivative positions included in the plurality of derivatives positions, and/or a user may identify the one or more spread positions between different derivatives positions 310 held in the account 210. The one or more spread positions associated with the account 310 may include a spread position between a first derivatives position (e.g., the derivative position A of FIG. 3) associated with the account and a second derivatives position associated with the account (e.g., the derivative position B of FIG. 3). In some cases, the exchange computer system 100 may be configured to determine a spread ratio between the two derivative positions 310 included in each of the one or more spread positions 230. In some cases, the spread positions 230 may include one or more inter-market spread position and/or one or more intra-market (e.g., calendar) spread positions. In some cases, the method 400 may include determining, by the linear programming module 250, a number of contracts subject to the associated first margin requirement of each of the plurality of derivatives positions 310 and determining a number of spreads 230 subject to the second spread margin requirement associated with each of the one or more spread positions.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that some steps illustrated in the figures may be performed in other than the recited order, and that one or more steps illustrated may be optional in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
(a) calculating, by a computer system, a first margin requirement for each of a plurality of derivatives positions associated with an account;
(b) calculating, by the computer system, a second spread margin requirement for each of one or more spread positions corresponding to the plurality of derivatives positions associated with the account; and
(c) determining, by the computer system, a minimum third account margin requirement for the account using a linear programming technique and based on the first margin requirement for each of the plurality of derivatives positions and the second spread margin requirement for each of the one or more spread positions.

2. The method of claim 1, further comprising determining, by the computer system, the one or more spread positions between two derivative positions included in the plurality of derivatives positions.

3. The method of claim 2, wherein the one or more spread positions correspond to a relationship between a first derivatives position associated with the account and a second derivatives position associated with the account.

4. The method of claim 2, further comprising determining, by the computer system, a spread ratio between the two derivative positions included in each of the one or more spread positions.

5. The method of claim 1, wherein the one or more spread positions include an inter-market spread position.

6. The method of claim 1, wherein the one or more spread positions include a calendar spread position.

7. The method of claim 1, wherein the one or more spread positions include both an inter-market spread position and a calendar spread position.

8. The method of claim 1, wherein determining, by the computer system, the minimum third account margin requirement for the account using the linear programming technique and based on the first margin requirement for each of the plurality of derivatives positions and the second spread margin requirement for each of the one or more spread positions includes:
determining, by the computer system, a number of contracts subject to the first margin requirement of each of the plurality of derivatives positions; and
determining, by the computer system, a number of spreads subject to the second spread margin requirement associated with each of the one or more spread positions.

9. One or more non-transitory computer-readable media storing computer executable instructions that, when executed, cause a computer system to perform operations that include:
(a) identifying an account including two or more derivatives positions, wherein each of the derivatives positions has an associated first margin requirement;
(b) calculating a second spread margin requirement for each of one or more spread positions corresponding to the two or more derivatives positions included in the account; and
(c) determining a minimum third account margin requirement for the account using a linear programming technique and based on the first margin requirement for each of the two or more derivatives positions and the second spread margin requirement for each of the one or more spread positions.

10. The one or more non-transitory computer-readable media of claim 9, wherein the instructions further comprise instructions that, when executed, cause the computer system to perform operations that include calculating the first margin requirement for each of the two or more derivatives positions associated with the account.

11. The one or more non-transitory computer-readable media of claim 9, wherein the instructions further comprise instructions that, when executed, cause the computer system to perform operations that include determining the one or more spread positions corresponding to the two or more derivatives positions associated with the account.

12. The one or more non-transitory computer-readable media of claim 11, wherein the second spread margin requirement for each particular spread position is less than a sum of the margin requirement of the derivatives positions corresponding to the particular spread position.

13. The one or more non-transitory computer-readable media of claim 11, wherein the one or more spread positions include an inter-market spread position, a calendar spread position, or both the inter-market spread position and the calendar spread position.

14. The one or more non-transitory computer-readable media of claim 9, wherein the instructions further comprise instructions that, when executed, cause the computer system perform operations that include determining a spread ratio between the two derivative positions included in each of the one or more spread positions.

15. The one or more non-transitory computer-readable media of claim 9, wherein the instructions further comprise instructions that, when executed, cause the computer system, perform operations that include:
determining a number of contracts subject to the associated first margin requirement for each of the two or more derivatives positions; and
determining a number of spreads subject to the second spread margin requirement associated with each of the one or more spread positions.

16. A computing system comprising:
at least one processor; and
at least one non-transitory memory, wherein the at least one non-transitory memory stores instructions that, when executed, cause a computing system to perform operations that include:
(a) receiving account information including a plurality of derivatives positions held in the account, wherein each of the derivatives positions have an associated first margin requirement;
(b) calculating a second spread margin requirement for each of one or more spread positions corresponding to the plurality of derivatives positions included in the account; and
(c) determining a minimum third account margin requirement for the account using a linear programming technique and based on the first margin requirement for each of the plurality of derivatives positions and the second spread margin requirement for each of the one or more spread positions.

17. The computing system of claim 16, further comprising a user interface, the user interface configured to communicate information about the minimum third account margin requirement to a user.

18. The computing system of claim 17, wherein the information about the third account margin requirement includes a number of contracts subject to the associated first margin requirement of each of the plurality of derivatives positions and a number of spreads subject the second spread margin requirement associated with each of the one or more spread positions.

19. The computing system of claim 16, wherein the non-transitory memory further comprise instructions that, when executed, cause the computing system, perform operations that include,
determining, by the computing system, a number of contracts subject to the associated first margin requirement of each of the plurality of derivatives positions; and
determining, by the computing system, a number of spreads subject to the second spread margin requirement associated with each of the one or more spread positions.

20. The computing system of claim 16, wherein the linear programming technique includes at least one of a simplex algorithm, a criss-cross algorithm, a conic sampling algorithm, an ellipsoid algorithm, a projective algorithm, and/or a path-following algorithm.
